(19) United States
(12) Patent Application Publication
(10) Pub. No.: US 2012/0133288 A1
(43) Pub. Date: May 31, 2012

(54) CIRCUIT STRUCTURE CAPABLE OF STRAIGHT/REVERSE CONNECTION OF POSITIVE AND NEGATIVE ELECTRODES OF AN INPUT POWER SOURCE

(76) Inventor: Xiang-You Jia, Sinjhuang City (TW)

(21) Appl. No.: 12/956,149

(22) Filed: Nov. 30, 2010

(51) Int. Cl. H05B 37/00; H02H 3/00

(52) U.S. Cl. 315/185 R; 361/84

(57) ABSTRACT

The present invention provides a circuit structure capable of straight/reverse connection of positive and negative electrodes of an input power source, which includes a load, an input power portion, a protection unit, a first switch unit and a second switch unit. The first switch unit and the second switch unit can respectively select an ON or OFF state based on the electrical polarities of a first electrode end and a second electrode end of the input power portion. By this arrangement, the circuit structure of the present invention can be operated normally no matter whether the positive and negative electrodes of the input power source are straightly or reversely connected.

### BACKGROUND OF THE INVENTION

1. Field of the Invention

The present invention relates to a circuit structure capable of straight/reverse connection of positive and negative electrodes of an input power source, which can be operated with reduced time and improved convenience. Further, the circuit structure of the present invention can be operated normally no matter whether the positive and negative electrodes of the input power source are straightly or reversely connected.

2. Description of Prior Art

The positive and negative electrodes of a DC power source are electrically connected to an internal circuit of a load according to a predetermined electrical path. If the positive and negative electrodes of the input power source are reversely connected to the internal circuit of the load, the internal circuit of the load will suffer damage and even burn down. In order to solve this problem, conventionally, one or more diodes are provided between the positive and negative electrodes of the input power source and the internal circuit of the load to protect the internal circuit of the load from suffering damage when the positive and negative electrodes of the input power source are reversely connected.

When the positive and negative electrodes of the input power source are straightly connected to the load, the electric current of the input power source passes through the diodes in a straight direction, so that the diodes becomes an ON state to allow the electric current to pass through the internal circuit of the load to drive the load for operation. When the positive and negative electrodes of the input power source are reversely connected to the load, the electric current of the input power source passes through the diodes in a reverse direction, so that the diodes becomes an OFF state to prohibit the electric current from passing through the internal circuit of the load. As a result, since an open circuit is formed, the load cannot be driven for operation, thereby protecting the internal circuit of the load from suffering damage.

Although the above solution can protect the internal circuit of the load from suffering damage when the positive and negative electrodes of the input power source are reversely connected to the load, it still has another problem that the load cannot be driven for operation when the positive and negative electrodes of the input power source are reversely connected to the load. As a result, a user has to correctly re-connect the positive and negative electrodes of the input power source to the load otherwise the load cannot be driven for operation, which wastes a lot of time and makes the user inconvenient in use.

According to the above, the prior art has disadvantages as follows:

(1) the load cannot be driven for operation when the positive and negative electrodes of the input power source are reversely connected to the load;

(2) the convenience in use is deteriorated; and

(3) more time is wasted.

Therefore, it is an important issue for the present inventor and the manufacturers in this filed to solve the above-mentioned problems in prior art.

### SUMMARY OF THE INVENTION

In order to solve the above problems, an objective of the present invention is to provide a circuit structure capable of straight/reverse connection of positive and negative electrodes of an input power source, which can be operated normally no matter whether the positive and negative electrodes of the input power source are straightly or reversely connected.

Another objective of the present invention is to provide a circuit structure capable of straight/reverse connection of positive and negative electrodes of an input power source, which can be operated with reduced time and improved convenience.

In order to achieve the above objective, the present invention is to provide a circuit structure capable of straight/reverse connection of positive and negative electrodes of an input power source, including: a load; an input power portion having a first electrode end and a second electrode end; a protection unit electrically coupled to the first electrode end, the second electrode end and one end of the load; a first switch unit electrically coupled to the first electrode end, the second electrode end and the protection unit for selecting an ON or OFF state based on electrical polarities of the first electrode end and the second electrode end; and a second switch unit electrically coupled to the first electrode end, the second electrode end, the first switch unit and the protection unit for selecting an ON or OFF state based on the electrical polarities of the first electrode end and the second electrode end, the other end of the load being electrically coupled to the first switch unit and the second switch unit. By using a combination of the first switch unit, the second switch unit and the protection unit, the circuit structure of the present invention can be operated with reduced time and improved convenience. Further, the present invention can be operated normally no matter whether the positive and negative electrodes of the input power source are straightly or reversely connected, thereby protecting the load from suffering damage.

### BRIEF DESCRIPTION OF THE DRAWINGS

FIG. 1 is a block view showing a preferred embodiment of the present invention;

FIG. 2 is a circuit view showing the preferred embodiment of the present invention; and

FIG. 3 is another circuit view showing the preferred embodiment of the present invention.

### DETAILED DESCRIPTION OF THE INVENTION

The above objectives and structural and functional features of the present invention will be described in more detail with reference to preferred embodiments thereof shown in the accompanying drawings

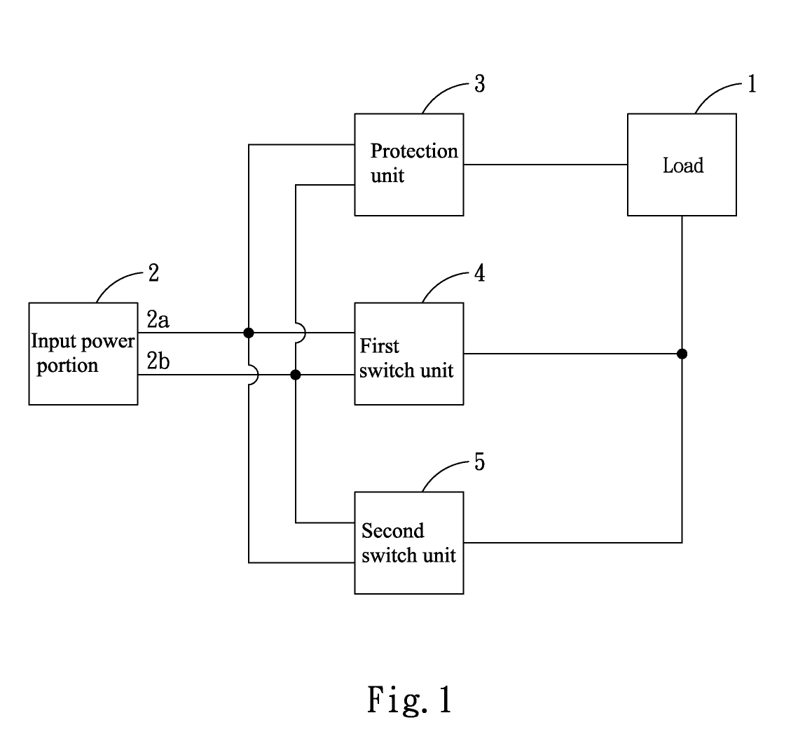

Please refer to FIG. 1. The present invention provides a circuit structure capable of straight/reverse connection of positive and negative electrodes of an input power source, which includes a load 1, an input power portion 2, a protection unit 3, a first switch unit 4 and a second switch unit 5. The input power portion 2 is configured to supply electricity to a connected circuit. The input power portion 2 has a first electrode end 2a and a second electrode end 2b. The electrical polarity of the first electrode end 2a matches that of the second electrode end 2b. That is, when the first electrode end 2a is of positive polarity, the second electrode end 2b is of negative polarity. When the first electrode end 2a is of negative polarity, the second electrode end 2b is of positive polarity.

The protection unit 3 is electrically coupled to the first electrode end 2a, the second electrode end 2b of the input power portion 2 and one end of the load 1 for allowing the electricity to be supplied to the load 1 only if the first electrode end 2a or the second electrode end 2b is of positive polarity. Thus, the load 1 can be driven for operation only if the first electrode end 2a is of positive polarity and the second electrode 2b is of negative polarity (or vice versa), thereby protecting the load 1 from suffering damage. In other word, the protection unit 3 is capable of protecting the internal circuit of the load. The other end of the load 1 is electrically coupled to the first switch unit 4 and the second switch unit 5.

The first switch unit 4 is electrically coupled to the first electrode end 2a, the second electrode end 2b and the protection unit 3 for selecting an ON or OFF state based on the electrical polarities of the first electrode end 2a and the second electrode end 2b. That is, when the first switch unit 4 is electrically coupled to the first electrode end 2a of positive polarity and the second electrode end 2b of negative polarity, the first switch unit 4 cannot be triggered, so that it becomes an OFF state. As a result, a loop circuit is not formed between the input power portion 2 and the load 1. When the first switch unit 4 is electrically coupled to the first electrode end 2a of negative polarity and the second electrode end 2b of positive polarity, the first switch unit 4 can be triggered, so that it becomes an ON state. At this time, a loop circuit is formed between the input power portion 2 and the load 1, so that the load 1 can be driven for operation.

The second switch unit 5 is electrically coupled to the first electrode end 2a, the second electrode end 2b, the first switch unit 4 and the protection unit 3 for selecting an ON or OFF state based on the electrical polarities of the first electrode end 2a and the second electrode end 2b. That is, when the second switch unit 5 is electrically coupled to the first electrode end 2a of positive polarity and the second electrode end 2b of negative polarity, the second switch unit 5 can be triggered, so that it becomes an ON state. As a result, a loop circuit is formed between the input power portion 2 and the load 1, so that the load 1 can be driven for operation. When the second switch unit 5 is electrically coupled to the first electrode end 2a of negative polarity and the second electrode end 2b of positive polarity, the second switch unit 5 cannot be triggered, so that it becomes an OFF state. At this time, a loop circuit is not formed between the input power portion 2 and the load 1.

According to the above, since the first switch unit 4 and the second switch unit 5 alternately become an ON state, the load 1 can be normally driven for operation regardless of the electrical polarities of the first electrode end 2a and the second electrode end 2b of the input power portion 2. Therefore, the circuit structure of the present invention can be operated with reduced time and improved convenience. Further, the circuit structure of the present invention can be operated normally no matter whether the positive and negative electrodes of the input power source are straightly or reversely connected.

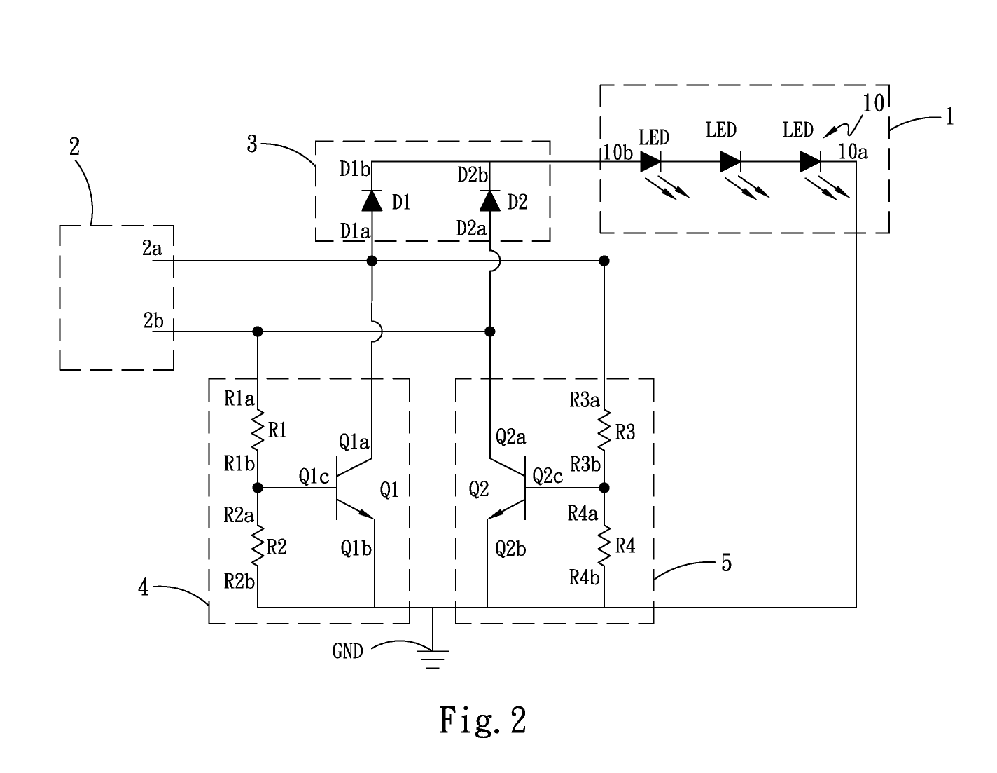

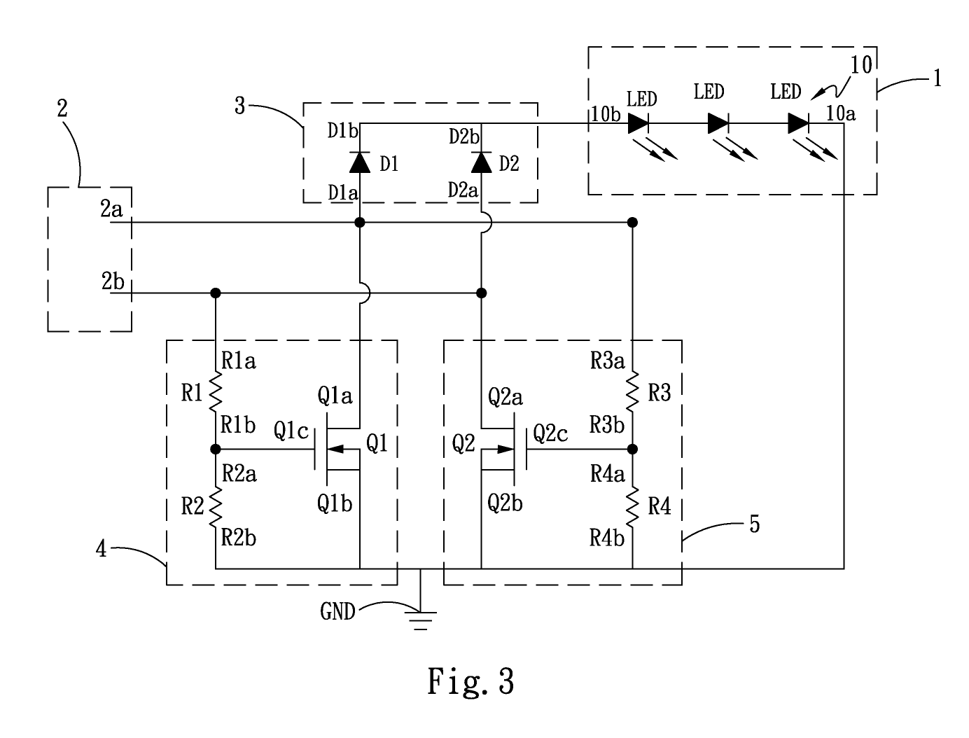

Please refer to FIGS. 2 and 3. The respective components of the present invention will be described in further detail.

The protection unit 3 comprises a first diode D1 and a second diode D2. The first diode D1 has a first anode end D1a and a first cathode end D1b. The first anode end D1a is selectively coupled to the first electrode end 2a of the input power portion 2. The second diode D2 has a second anode end D2a and a second cathode end D2b. The second anode end D2a is selectively coupled to the second electrode end 2b. The second cathode end D2b is electrically coupled to the first cathode end D1b and one end of the load 1.

The load 1 may be a light-emitting diode module, an electronic product, a portable electronic device or the like. In the present embodiment, a LED module 10 is used as an example of the load 1. The LED module 10 has a plurality of LEDs connected in series. The LED module 10 has a front end 10a electrically coupled to a ground GND (that is, the other end of the load 1 is electrically coupled to the ground GND) and a rear end electrically coupled to the first cathode end D1b and the second cathode end D2b (that is, one end of the load 1 is electrically coupled to the first cathode end D1b and the second cathode end D2b).

The first switch unit 4 comprises a first resistor R1, a second resistor R2 and a first transistor Q1. The first resistor R1 has a first end R1a and a second end R1b. The first end R1a is electrically coupled to the second electrode end 2b of the input power portion 2. The second resistor R2 has a third end electrically coupled to the second end R1b and a fourth end R2b electrically coupled to the ground GND. That is, the first resistor R1 is electrically connected in series with the second resistor R2.

The first transistor Q1 is a Bipolar Junction Transistor (BJT) or Filed Effect Transistor (FET, MOSFET, JFET) and has a first terminal Q1a, a second terminal Q1b and a third terminal Q1c. The first terminal Q1a is electrically coupled to the first electrode end 2a and the first anode end D1a. The second terminal Q1b is electrically coupled to the fourth end R2b and the ground GND. The third terminal Q1c is electrically coupled to the second end R1b and the third end R2a. Thus, when the first terminal Q1a is electrically coupled to the first electrode end 2a of negative polarity, and the first end R1a is electrically coupled to the second electrode end 2b of positive polarity, the first transistor Q1 can be triggered to become an ON state. As a result, a loop circuit is formed between the input power portion 2 and the load 1, so that the load 1 can be driven for operation.

In practice, the user can select the first transistor Q1 from a BJT or a FET (MOSFET, JFET) based on demands. FIG. 2 shows that the first transistor Q1 is a BJT. The first terminal Q1a is collector. The second terminal Q1b is emitter. The third terminal Q1c is base. Alternatively, FIG. 3 shows that the first transistor Q1 is a FET (MOSFET, JFET). The first terminal Q1a is drain. The second terminal Q1b is source. The third terminal Q1c is gate. In FIG. 3, the FET is a NMOSFET.

The second switch unit 5 comprises a third resistor R3, a fourth resistor R4 and a second transistor Q2. The third resistor R3 has a fifth end R3a and a sixth end R3b electrically coupled to the first electrode end 2a. The fourth resistor R4 has a seventh end R4a electrically coupled to the sixth end R3b and an eighth end R4b electrically coupled to the ground GND. That is, the third resistor R3 is electrically connected in series with the fourth resistor R4.

The second transistor Q2 has a fourth terminal Q2a, a fifth terminal Q2b and a sixth terminal Q2c. The fourth terminal Q2a is electrically coupled to the second electrode end 2b and the second anode end D2a. The fifth terminal Q2b is electrically coupled to the eighth end R4b, the second terminal Q1b and the ground GND. The sixth terminal Q2c is electrically coupled to the sixth end R3b and the seventh end R4a. Thus, when the fifth end R3a is electrically coupled to the first electrode end 2a of positive polarity, and the fourth end Q2a is electrically coupled to the second electrode end 2b of positive polarity, the second transistor Q2 can be triggered to become an ON state. As a result, a loop circuit is formed between the input power portion 2 and the load 1, so that the load 1 can be driven for operation.

In practice, the second transistor Q2 is substantially the same as the first transistor Q1. The user can select the second transistor Q2 from a BJT or a FET (MOSFET, JFET) in such a manner that the second transistor Q2 matches the first transistor Q1. FIG. 2 shows that each of the first transistor Q1 and the second transistor Q2 is a BJT. Each of the first terminal Q1a and the fourth terminal Q2a is collector. Each of the second terminal Q1b and the fifth terminal Q2b is emitter. Each of the third terminal Q1c and the sixth terminal Q2c is base. Alternatively, FIG. 3 shows that each of the first transistor Q1 and the second transistor Q2 is a FET (MOSFET, JFET). Each of the first terminal Q1a and the fourth terminal Q2a is drain. Each of the second terminal Q1b and the fifth terminal Q2b is source. Each of the third terminal Q1c and the sixth terminal Q2c is gate. In FIG. 3, the FET is a NMOSFET/

Please refer to FIG. 2 again. An embodiment of the present invention will be described later, in which each of the first transistor Q1 and the second transistor Q2 is a BJT.

When the circuit structure of the present invention is electrically coupled to the first electrode end 2a of positive polarity and the second electrode end 2b of negative polarity, an electric current flows from the first electrode end 2a through the first diode D1, the LEDs, the third resistor R3 and the fourth resistor R4. The third resistor R3 and the fourth resistor R4 divide the voltage to the sixth terminal Q2c of the second transistor Q2, thereby triggering ON the second transistor Q2. Then, the electric current continues to flow through the second transistor Q2, the ground GND and to the second electrode end 2b to form a loop circuit. Finally, in this way, the LEDs emit light.

When the circuit structure of the present invention is electrically coupled to the first electrode end 2a of negative polarity and the second electrode end 2b of positive polarity, an electric current flows from the second electrode end 2b through the second diode D2, the LEDs, the first resistor R1 and the second resistor R2. The first resistor R1 and the second resistor R2 divide the voltage to the third terminal Q1c of the first transistor Q1, thereby triggering ON the first transistor Q1. Then, the electric current continues to flow through the first transistor Q1, the ground GND and to the first electrode end 2a to form a loop circuit. Finally, in this way, the LEDs emit light.

In comparison with prior art, the present invention has the following advantages:
(1) the load can be normally driven for operation no matter whether the positive and negative electrodes of the input power source are straightly or reversely connected;
(2) the convenience in use is improved; and
(3) time is saved.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A circuit structure capable of straight/reverse connection of positive and negative electrodes of an input power source, including:
a load;
an input power portion having a first electrode end and a second electrode end;
a protection unit electrically coupled to the first electrode end, the second electrode end and one end of the load;
a first switch unit electrically coupled to the first electrode end, the second electrode end and the protection unit for selecting an ON or OFF state based on electrical polarities of the first electrode end and the second electrode end; and
a second switch unit electrically coupled to the first electrode end, the second electrode end, the first switch unit and the protection unit for selecting an ON or OFF state based on the electrical polarities of the first electrode end and the second electrode end, the other end of the load being electrically coupled to the first switch unit and the second switch unit.

2. The circuit structure capable of straight/reverse connection of positive and negative electrodes of an input power source according to claim 1, wherein the protection unit comprises a first diode and a second diode, the first diode has a first anode end and a first cathode end, the first anode end is selectively coupled to the first electrode end, the second diode has a second anode end selectively coupled to the second electrode end and a second cathode end coupled to the first cathode end and one end of the load.

3. The circuit structure capable of straight/reverse connection of positive and negative electrodes of an input power source according to claim 2, wherein the first switch unit comprises:
a first resistor having a first end and a second end, the first end being electrically coupled to the second electrode end of the input power portion;
a second resistor having a third end electrically coupled to the second end and a fourth end electrically coupled to a ground; and
a first transistor having a first terminal, a second terminal and a third terminal, the first terminal being electrically coupled to the first electrode end and the first anode end, the second terminal being electrically coupled to the fourth end and the ground, the third terminal being coupled to a connecting point of the second end and the third end;
wherein the first transistor is triggered ON when the first terminal is electrically coupled to the first terminal end of negative polarity and the second electrode end of positive polarity.

4. The circuit structure capable of straight/reverse connection of positive and negative electrodes of an input power source according to claim 3, wherein the second switch unit comprises:
a third resistor having a fifth end and a sixth end electrically coupled to the first electrode end;
a fourth resistor having a seventh end electrically coupled to the sixth end and an eighth end electrically coupled to the ground; and
a second transistor having a fourth terminal, a fifth terminal and a sixth terminal, the fourth terminal being electrically coupled to the second electrode end and the second anode end, the fifth terminal being electrically coupled to the eighth end and the second end, the sixth terminal being electrically coupled to a connecting point of the sixth end and the seventh end;
wherein the second transistor is triggered ON when the fifth end is electrically coupled to the first electrode end of positive polarity and the fourth terminal is electrically coupled to the second electrode end of negative polarity.

5. The circuit structure capable of straight/reverse connection of positive and negative electrodes of an input power source according to claim 2, wherein the load is a LED module, the Led module has a plurality of light emitting diodes connected in series, the LED module has a front end electrically coupled to a ground, and a rear end electrically coupled to the first cathode end and the second cathode end.

6. The circuit structure capable of straight/reverse connection of positive and negative electrodes of an input power source according to claim 3, wherein the first transistor is a Bipolar Junction Transistor, the first terminal is collector, the second terminal is emitter, and the third terminal is base.

7. The circuit structure capable of straight/reverse connection of positive and negative electrodes of an input power source according to claim 4, wherein the second transistor is a Bipolar Junction Transistor, the fourth terminal is collector, the fifth terminal is emitter, and the sixth terminal is base.

8. The circuit structure capable of straight/reverse connection of positive and negative electrodes of an input power source according to claim 3, wherein the first transistor is a Field Effect Transistor, the first terminal is drain, the second terminal is source, and the third terminal is gate.

9. The circuit structure capable of straight/reverse connection of positive and negative electrodes of an input power source according to claim 4, wherein the second transistor is a Field Effect Transistor, the fourth terminal is drain, the fifth terminal is source, and the sixth terminal is gate.
